(19) United States
(12) Patent Application Publication
(10) Pub. No.: US 2004/0057573 A1
(43) Pub. Date: Mar. 25, 2004

(54) Keypads for oblique viewing

(76) Inventors: Victor G. Feller, Langhorne, PA (US); Gerry J. Elman, Swarthmore, PA (US)

Correspondence Address: ELMAN TECHNOLOGY LAW, P.C., P O BOX 209, SWARTHMORE, PA, 19081-0209, US

(21) Appl. No.: 10/601,835

(22) Filed: Jun. 23, 2003

Related U.S. Application Data
(60) Provisional application No. 60/391,094, filed on Jun. 24, 2002.

(51) Int. Cl. H04M 1/00; H04M 3/00

(52) U.S. Cl. 379/368

(57) ABSTRACT

A keypad is provided for optimal viewing from an off-axis vantage point, i.e., that is not perpendicular to the plane of the keypad, for a device such as a wireless phone clipped upside-down to a user's belt or a remote control pointed at a controlled device. At least a triad of keys have numerical or other visible indicia on a planar, or slightly convex or concave surface that is oblique to the plane. The keypad can be operated conveniently without having to shift viewpoint or move the device.

### CRO S REFERENCE TO RELATED APPLICATION

This application claims priority from U.S. Provisional Patent Application No. 60/391,094, filed Jun. 24, 2002, the entire contents of which are incorporated herein by reference.

### TECHNICAL FIELD

This invention relates to keypads such as for wireless telephones and remote control units, especially those having keys in rows of three, such as, for example, resenting the digits 1-2-3, 4-5-6, 7-8-9 and optionally *-0-#., or three or more control buttons.

### BACKGROUND ART

Wireless telephones have become common. Typically such phones are served via a cellular network using an analog or digital protocol, or they may alternatively be served by a central tower or sometimes even a communication satellite. Other wireless phones may be of the cordless variety, served by a local base station that is typically connected by a wired (landline) connection to the switched-service telephone network. Still other wireless phones may be varieties of two-way radio handsets. In general, a wireless phone suitable for use with the present invention has a keypad with a multiplicity of buttons, generally at least 10, representing the digits from 0 to 9, and optionally two more, as provided by a conventional 12-button DTMF keypad. The buttons of the conventional keypad, arranged in rows of three keys each, or “triads,” generally have a flat or slightly convex shape where the characters and/or other indicia are printed (or otherwise made perceptible as by backlighting through translucent material). On larger keypads, such buttons may be slightly concave. Usually together the buttons thereby define a surface parallel to the faceplate of the telephone. Other buttons having control functions are typically also present on keypads of wireless phones. Preferably (but not necessarily) such a phone also includes a numeric or alphanumeric display (which may also include graphical functionality).

It has become customary to mount such phones in carrying cases of leather or plastic having openings through which the display screen is visible and the keypad is accessible. Such cases are typically provided with belt clips or with other means for securing the case to a mounting. However, to communicate via the phone, the user must generally remove it from his belt and hold it in his hand, which is at least an inconvenience and in some circumstances, creates a potentially unsafe condition.

The mobility and convenience of such phones has led to their being used while walking and while driving vehicles. To allay concerns over safety, it has been recommended (and in some jurisdictions, legislated) that the user avoid placing the phone as a handset held to the ear, but rather that the phone be mounted somewhere (e.g. on a belt or the dashboard of a car) and communicated with remotely, as via a headset, e.g. an ear bud and microphone.

In another aspect, the present invention applies to remote controls (“remotes”) with multiple keys, e.g. for television sets, audio systems, home entertainment systems, and the like. Such remotes may have numeric keypads such as described above, also including a variety of control buttons, or they may simply have a variety of control buttons without numbers. They typically are configured to lie horizontally, e.g. on a table, until picked up by a user and held in one hand as the user presses one or more of the keys with a finger, generally of the other hand. However, such remotes commonly have a light-emitter at one end, e.g. of infrared or visible light, and are optimally used within line of sight from the receiver and for best results are used while being pointed directly at the receiver. Reflections of the remote's signal from the environment may sometimes allow the remote to work even when it is not pointed directly at the receiver, though this is often unreliable. A more convenient remote control device would be desirable.

### DISCLOSURE OF INVENTION

The present invention provides improved visibility for indicia shown on keypads when viewed from a vantage point that's off the axis perpendicular to the base of the keypad. In a particular embodiment, it allows for using a wireless phone with increased safety and convenience while using a headset. Typically the headset is connected to the phone by wire, but alternatively a wireless connection, e.g. Bluetooth, may be used between the phone and headset. This invention allows the user to dial via the keypad without having to unclip the phone from a secure mounting, e.g. his belt. The invention provides a keypad wherein the number and any other character(s) or icons represented by each key is displayed on a key surface that is oblique to the plane defined by the keypad or faceplate of the phone. The key surface may be generally flat or may optionally be somewhat convex or concave.

In one embodiment, a keypad replacement is provided. It is preferably used with means for detachably securing the phone in an upside-down position to a belt or other substrate. The securing means may be a case or mounting for the phone with an upside-down clip. The conventional keypad is substituted by the keypad replacement. The indicia (a number and optionally the corresponding letters or other characters) are printed (or otherwise made visible, as by being transparent or translucent and optionally backlit) on a surface which is oblique to the base plane of the keypad.

Another variation of this invention is a wireless phone with a display, e.g. an LCD, that in use is oblique to the plane of the keypad or otherwise made for optimal viewing when seen obliquely from above, together with a keypad in accordance with this invention and a mounting for securing the phone upside-down to the user. The LCD may be fixed into such an oblique position, but is optimally installed on a hinged element that opens to a desired angle. Such a phone may be conveniently used on the belt from a sitting position. Desirably the mounting is a clip secured to a case for the phone, e.g. of leather, for mounting the phone in an upside-down position on the user's belt. Optionally the mounting may provide for a plurality of positions the user can temporarily set, as by a detent. Alternatively such a phone may be provided with its own mounting, e.g. a belt clip, avoiding the necessity for a case.

Another variation of this invention is a remote control having indicia on keys that may conveniently be viewed and operated while being pointed directly away from the user so as to operate the controlled device.

In one aspect, the present invention provides a keypad optimized for off-axis viewing, comprising one or more triads of keys in a row protruding from a faceplate surface, each such key bearing an indicium representative of the result of pressing the key, the indicium being on a key surface that is oblique to the plane defined by the faceplate surface.

Preferably the keypad comprises three triads of keys representing numbers from 1 to 9.

More preferably, the keypad further includes a fourth triad of keys, one representing the number 0 and the other two representing functions, e.g. represented by the characters * and #. The invention also contemplates triads of keys, each bearing non-numeric indicia.

The keys may be formed integrally with a common base from which they protrude through the faceplate.

The invention provides a wireless phone comprising a keypad as taught hereinabove.

The invention also provides a mounting for a wireless phone optimized for off-axis viewing and operation, comprising a keypad as taught hereinabove and a clip for temporarily securing the wireless phone in the upside-down position for manual operation at or near the waist of a user.

The invention further provides a kit for retrofitting a conventional wireless phone for off-axis viewing comprising a replacement keypad as taught hereinabove. Such a kit may optionally include a mounting comprising a clip for temporarily securing the wireless phone in the upside-down position for manual operation at or near the waist of a user.

The invention also provides a remote control device comprising a keypad as taught hereinabove. The remote may use infrared or other line-of-sight means of communication with a sensor on the controlled device.

### BRIEF DESCRIPTION OF THE DRAWINGS

FIG. 1 shows a side view of a replacement keypad that embodies the present invention.

FIG. 2 shows a front view of the replacement keypad of FIG. 1.

FIG. 3 shows a side view of a conventional wireless phone to which the replacement keypad of FIG. 1 has been applied, and a clip has been added that facilitates mounting the phone upside down.

FIG. 4 shows a front view of the wireless phone of FIG. 3.

FIG. 5 shows an oblique view from above of the wireless phone of FIG. 3, taken from the vantage point of a user, in the direction of the arrow -5- shown in FIG. 3.

FIG. 6 shows a side view of a modification of a wireless phone having a keypad produced in accordance with the present invention, and a specially oriented display and upside-down mounting clip to facilitate use when viewed obliquely from above.

FIG. 7 shows a front view of the wireless phone of FIG. 6.

FIG. 8 shows an oblique view from above of the wireless phone of FIG. 6, taken from the vantage point of a user, in the direction of the arrow -8- shown in FIG. 6.

FIG. 9 shows a front view of a remote control device embodying the invention.

FIG. 10 shows a side view of the remote control device of FIG. 9.

FIG. 11 shows an oblique view from above of the remote control of FIG. 9, taken from the vantage point of a user, in the direction of the arrow -11- shown in FIG. 10.

### MODES OF CARRYING OUT THE INV NTION

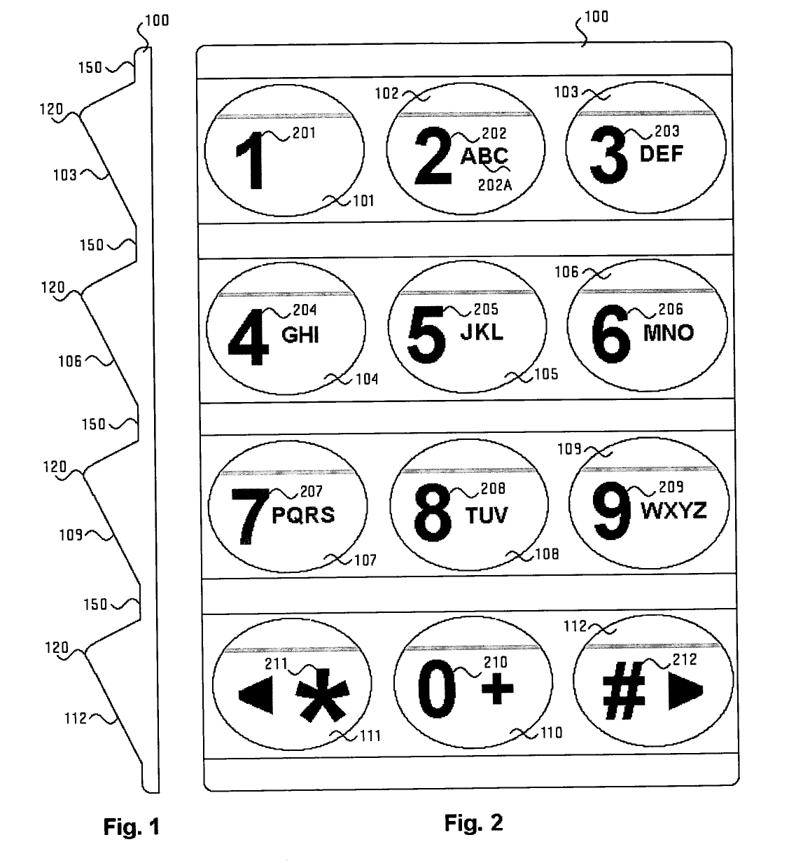

As shown in FIG. 1, a keypad replacement 100 of flexible plastic or rubbery material is provided in accordance with one embodiment of the present invention. The front 150 of the keypad replacement 100 has a multiplicity of key protrusions or bumps 120 on its surface, one for each key of the keypad. Typically there would be four rows of three keys each, and so a typical keyboard overlay would have twelve such bumps 120. Preferably the bumps 120 are pre-formed to approximate the size and shape of the keys of a keypad of a typical wireless phone. The keypad replacement may be marketed in various configurations, made to the exact measurements of keypads of various models of conventional wireless phones, e.g. cell phones of Nokia, Ericsson, Motorola, Kyocera, Samsung and the like.

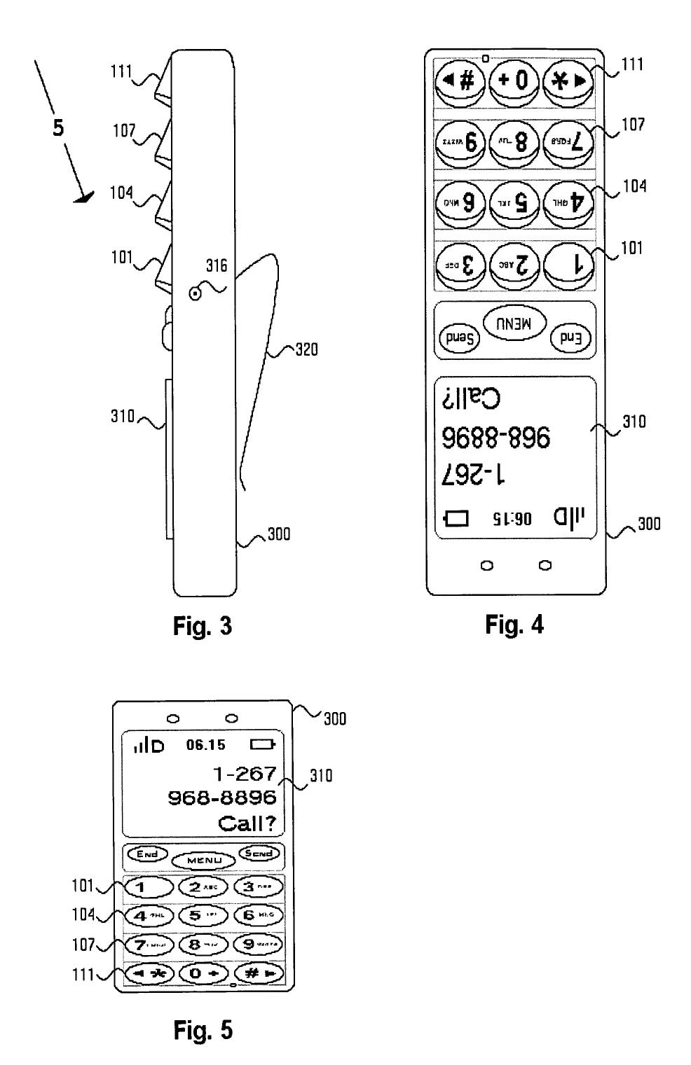

As shown particularly in FIGS. 1 and 3, each bump 120 is formed with a key surface (e.g. 103, 106, 109, 112). As shown in FIGS. 2, 7 and 8, an indicium 201, 202, 203, 204, 205, 206, 207, 208, 209, 210, 211, 212, preferably a numeral (e.g. as marked at 201) and other characters (e.g. as marked at 202A), is printed or otherwise displayed (e.g. embossed or provided as a translucent backlit character). The bumps are typically arranged in rows of three, i.e. triads.

Preferably the angle of each key surface 103, 106, 109, 112 is approximately 45 degrees to the plane of the front 150 of the overlay or of a plane defined by the topmost parts of each of the key tops. It may desirably be anywhere from 15 degrees to 75 degrees, and indeed may sometimes be acceptable if 5 degrees to 85 degrees. The important thing is that the key surface 103, 106, 109, 112 be oriented so that when the indicia thereon (e.g. 203, 206, 209,212) are viewed obliquely from the user vantage point, it will be easily seen and interpreted. This would happen, e.g., when a user looks down at a wireless phone mounted upside-down on his belt, as shown by arrow -5- in FIG. 3.

Each key surface (e.g. 103, 106, 109, 112) may be flat or may be somewhat rounded, as is conventional with the surface of keys on a conventional wireless phone. Alternatively, it is sometimes desirable to provide key surfaces that are somewhat concave, as is typical on keypads of some conventional desktop phones.

FIG. 3 illustrates a wireless phone 300 having a conventional display screen 310 and being provided with a keypad 100 in accordance with the present invention. In accordance with the invention, the keypad 100, which includes key surfaces 101, 104, 107, 111, is particularly adapted for viewing from an angle shown generally by the arrow -5- in FIG. 3. FIGS. 3 and 4 show the phone as it would appear from afar when mounted on the user belt. FIG. 5 shows the phone as it would be seen when viewed by the user obliquely from above.

A clip 320 is provided to secure the phone 300 to the user's belt or other place of securement, e.g generally near the waist, from which the phone may be conveniently operated. The clip may be fastened directly to the phone housing or to a separate case such as is marketed as an accessory. It is conventional for such clips or holders or cases to hold the phone right-side-up, so that the display is above the keypad. This is fine for carrying the phone around, but in use, the phone must be unclipped from the belt and manipulated by the user. However, in accordance with a preferred embodiment of the present invention, the clip or holder or case (to the contrary) is adapted to hold the phone upside-down. Inverting the orientation of the phone in accordance with this invention facilitates use of the phone without needing to remove it from the user's belt. A jack 316 connects to a conventional headset (not shown).

Alternatively, if the phone includes a belt clip, or if the user already has a case with a clip that, although intended for holding the phone right-side-up, is nevertheless capable of securing the phone to the belt upside down, the user may use the conventional clip with a keypad 100 of the present invention. As another alternative in accordance with the invention, one may use a mounting that allows the phone to rotate about a horizontal axis but which has stops or detents that allow the user to temporarily secure the phone in a desired position that is upside-down or nearly so.

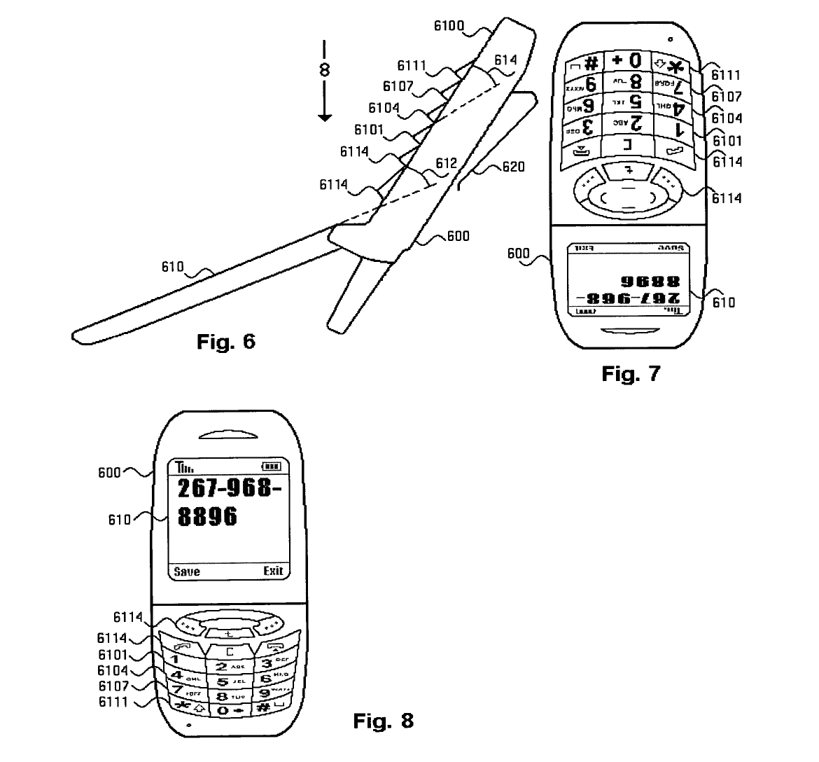

FIGS. 6 to 8 illustrate another embodiment of the invention wherein a wireless phone 600 is manufactured with a keypad 6100 that is adapted for being viewed from approximately the angle represented by the arrow -8- in FIG. 6. The individual key surfaces, e.g. 6101, 6104, 6107, 6111, are generally disposed at an oblique angle 614 to the plane of the keypad and its faceplate, as described above in connection with the embodiment shown in FIGS. 1-5.

The phone 600 includes a display 610. Desirably, as shown in FIG. 6, the display 610 is mounted to flip open (or otherwise is capable of being viewed) at an angle 612 to a line perpendicular to the plane of the keypad 6100. The angle 612 is chosen so that the subject matter shown on the display 610 may be conveniently viewed from approximately the vantage point represented by the arrow -8- in FIG. 6. The angle 612 may be, but does not have to be, identical to angle 614. A jack 616 connects to a conventional headset (not shown). Alternatively, a wireless connection to a headset is provided.

A triad of keys 6111 show characters defining the operation of the keys, of which the central key contains the numeral 0 and a + sign. Key triad 6101 show the numerals 1, 2, and 3 respectively, along with letters traditionally associated with the 2 and 3 keys. Key triad 6104 show 4, 5 and 6 respectively, along with the letters traditionally associated with those three keys. Key triad 6107 shows the numerals 7, 8 and 9 along with their associated letters.

Keys 6114 are control keys, the functions and configuration of which may vary from model to model of wireless phone.

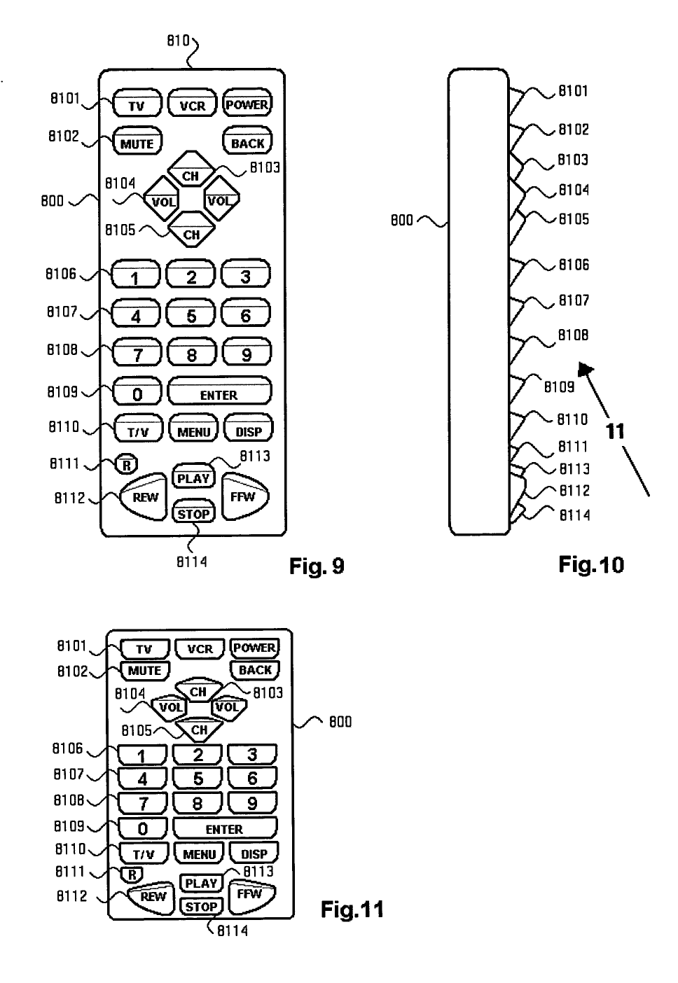

FIGS. 9 to 11 show a remote control device (“remote”) 800 in accordance with the present invention. As is conventional, a source 810 of infrared or other light is mounted within the remote 800. Various layouts of remotes are conventional, and the present invention contemplates use with any such layout.

A triad of keys 8101 here define the functions TV, VCR, and POWER respectively. Keys 8102 define the MUTE and BACK functions. A pair of keys 8104 control volume. Key 8103 moves channel selection up, and key 8104 moves the channel down. A triad of keys 8106 bear the numerals 1, 2 and 3. Another triad 8107 bears numerals 4, 5, and 6. Yet another triad of keys 8108 bears 7, 8, and 9. Keys 8109 bear the numeral 0 and the function ENTER. Triad 8110 bear the functions TN, MENU and DISP. Key 8111 bears the function R. Keys 8112 bear the functions REW and FFW. Key 8113 bears PLAY. Key 8114 bears STOP.

As shown in FIG. 8, the key tops are oblique to the plane defined by the surface of the remote, and similarly are oblique to the plane defined by the tops of the keys themselves. Accordingly, a viewer looking in the direction of arrow 11 in FIG. 10 would view the remote 800 as shown in FIG. 11, wherein each of the indicia on each of the keys is legible to the user.

The reader will appreciate that variations may be made within the scope and spirit of the invention taught hereinabove.

Some embodiments of the invention may provide rows of more than three keys, of which any three would constitute a “triad” as taught above.

1. A keypad optimized for off-axis viewing, comprising one or more triads of keys in a row protruding from a faceplate surface, each such key bearing an indicium representative of the result of pressing the key, the indicium being on a key surface that is oblique to the plane defined by the faceplate surface or by the topmost portion of each of the keys.

2. The keypad of claim 1, comprising three triads of keys representing numbers from 1 to 9.

3. The keypad of claim 2, further comprising a fourth triad of keys, one representing the number 0 and the other two representing functions.

4. The keypad of claim 3, wherein the other two functions are represented by the characters * and #.

5. The keypad of claim 1 wherein the keys are formed integrally with a common base from which they protrude through the faceplate.

6. A wireless phone comprising a keypad as recited in claim 1.

7. A mounting for a wireless phone optimized for off-axis viewing and operation, comprising a keypad as recited in claim 1 and a clip for temporarily securing the wireless phone upside-down for manual operation at or near the waist of a user.

8. A kit for retrofitting a conventional wireless phone for off-axis viewing comprising a replacement keypad as recited in claim 1.

9. The kit of claim 8, further comprising a mounting comprising a clip for temporarily securing the wireless phone upside-down for manual operation at or near the waist of a user.

10. A remote control device comprising a keypad as recited in claim 1.

11. The keypad of claim 1, wherein the indicia on the keys of at least one triad do not include numbers.
